(19) United States
(12) Patent Application Publication
(10) Pub. No.: US 2025/0020311 A1
(43) Pub. Date: Jan. 16, 2025

(54) LIGHTING DEVICE

(71) Applicant: Japan Display Inc., Tokyo (JP)

(72) Inventors: Masafumi OKADA, Tokyo (JP); Nobuyuki SUZUKI, Tokyo (JP); Makoto HASEGAWA, Tokyo (JP)

(73) Assignee: Japan Display Inc., Tokyo (JP)

(21) Appl. No.: 18/765,444

(22) Filed: Jul. 8, 2024

(30) Foreign Application Priority Data
Jul. 14, 2023 (JP) 2023-115927

(51) Int. Cl. F21V 7/00; G02B 27/30

(52) U.S. Cl. CPC F21V 7/0091; G02B 27/30

(57) ABSTRACT

A lighting device includes a light source capable of emitting light and a collimator lens. The collimator lens has a recess facing the light source. The recess includes an interior surface. The interior surface includes a bottom surface smaller than an opening. The interior surface includes an inner side surface tapering toward the bottom surface. The inner side surface is generated by rotating a straight line around an optical axis of the light. The straight line is inclined at an angle of at least 10 degrees and at most 20 degrees with respect to the optical axis. The light enters the bottom surface at a light distribution angle of only three degrees or less with respect to the optical axis, and enters the inner side surface at a light distribution angle of more than three degrees with respect to the optical axis.

### CROSS-REFERENCE TO RELATED APPLICATION

The present application claims priority from Japanese patent application JP2023-115927 filed on Jul. 14, 2023, the contents of which are hereby incorporated by reference into this application.

### BACKGROUND

### 1. Field

The present disclosure relates to a lighting device.

### 2. Description of the Related Art

Some lighting devices require light (ideally parallel light) with a narrow light distribution angle (JP 2018-88326 A). A collimator lens can be used to obtain the parallel light (JP 2015-60631 A).

The collimator lens, which is equipped with refractive and reflective surfaces of the light, encounters challenges in enhancing curvature of the refractive surface, complicating achievement of the narrow light distribution angle.

### SUMMARY

The present disclosure aims to achieve a narrow light distribution angle.

A lighting device includes: a light source capable of emitting light; and a collimator lens including an incident surface of the light and an exit surface of the light, the collimator lens including an outer surface around the incident surface and the exit surface, the outer surface being capable of internally reflecting part of the light, the collimator lens having a recess facing the light source, the recess including an interior surface, the interior surface including a bottom surface smaller than an opening, the interior surface including an inner side surface tapering toward the bottom surface, the inner side surface being generated by rotating a straight line inclined at an angle of at least 10 degrees and at most 20 degrees with respect to an optical axis of the light, around the optical axis, wherein the light enters the bottom surface at a light distribution angle of only three degrees or less with respect to the optical axis, and enters the inner side surface at a light distribution angle of more than three degrees with respect to the optical axis, exiting light from the exit surface includes incident light from the bottom surface and reflected light from the outer surface, and the reflected light is light from the inner side surface.

Due to reduced light incidence on the bottom surface of the recess, a higher level of light reflection from the outer surface is possible, consequently achieving a narrow light distribution angle.

### BRIEF DESCRIPTION OF THE DRAWINGS

FIG. 1 is a schematic cross-sectional view of a lighting device according to an embodiment.

FIG. 2 is a luminance distribution diagram of the lighting device according to the embodiment.

FIG. 3 is an illuminance distribution diagram of the lighting device according to the embodiment.

FIG. 4 is a schematic cross-sectional view of a lighting device according to a modification example of the embodiment.

FIG. 5 is a schematic cross-sectional view of a lighting device according to an application example of the embodiment.

### DETAILED DESCRIPTION

Hereinafter, some embodiments will be described with reference to the drawings. Here, the invention can be embodied according to various aspects without departing from the gist of the invention and is not construed as being limited to the content described in the embodiments exemplified below.

The drawings are further schematically illustrated in widths, thicknesses, shapes, and the like of units than actual forms to further clarify description in some cases but are merely examples and do not limit interpretation of the invention. In the present specification and the drawings, the same reference numerals are given to elements having the same functions described in the previously described drawings, and the repeated description will be omitted.

Further, in the detailed description, “on” or “under” in definition of positional relations of certain constituents, and other constituents includes not only a case in which a constituent is located just on or just under a certain constituent but also a case in which another constituent is interposed between constituents unless otherwise mentioned.

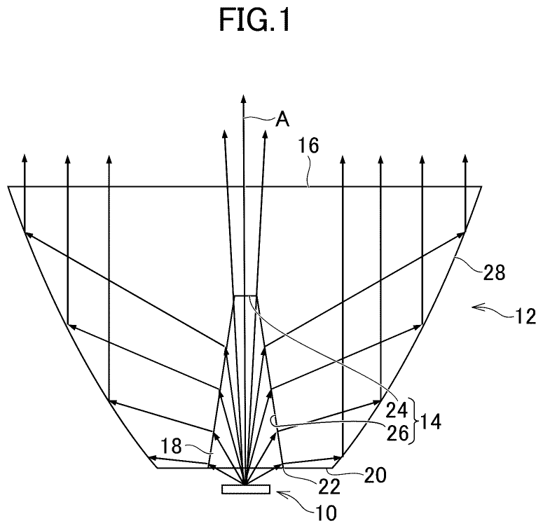

FIG. 1 is a schematic cross-sectional view of a lighting device according to an embodiment. The lighting device has a light source 10 (e.g., light-emitting diode or filament). The light source 10 is capable of emitting light (e.g., white light) that spreads from the optical axis A (central axis of the light beam). The light distribution angle of the light is less than 180 degrees (e.g., 120 to 130 degrees).

The lighting device includes a collimator lens 12. The collimator lens 12 is made of transparent resin or optical glass. The collimator lens 12 includes an incident surface 14 and an exit surface 16.

The collimator lens 12 has a recess 18 facing the light source 10. The light from the light source 10 entirely enters an interior surface of the recess 18. The interior surface of the recess 18 is the incident surface 14 of the light. The light source 10 is positioned outside the recess 18. The collimator lens 12 has, around the recess 18, a rear surface 20 that is flat and spreads in a direction perpendicular to the optical axis A. The opening 22 of the recess 18 is circular.

The interior surface of the recess 18 includes a bottom surface 24 smaller than the opening 22. The bottom surface 24 is a flat surface perpendicular to the optical axis A. The light enters the bottom surface 24 at a light distribution angle of only three degrees or less with respect to the optical axis A. The bottom surface 24 is part of the incident surface 14 of the light.

The interior surface of the recess 18 includes an inner side surface 26. The inner side surface 26 tapers towards the bottom surface 24. The inner side surface 26 is generated by rotating a straight line inclined at an angle of at least 10 degrees and at most 20 degrees with respect to the optical axis A of the light, around the optical axis A. The inner side surface 26 is another part (e.g., all portions except the bottom surface 24) of the incident surface 14. The light enters the inner side surface 26 at a light distribution angle of more than three degrees with respect to the optical axis A. The incident light is refracted by the inner side surface 26.

The collimator lens 12 includes an outer surface 28. The outer surface 28 is positioned around the incident surface 14. The outer surface 28 is capable of internally reflecting part (refracted light by the inner side surface 26) of the light. The outer surface 28 is a curved surface that protrudes in a direction opposite the optical axis A. The curved surface is generated by rotating a curve around the optical axis A. The curved surface is shaped to reflect the light, which is refracted by the inner side surface 26 and propagates directly, parallel to the optical axis A and towards the exit surface 16. The outer surface 28 may be covered with a light-reflective film.

The exit surface 16 is a flat surface perpendicular to the optical axis A. The exit surface 16 is circular. In diameter, the opening 22 of the recess 18 is one fifth or less of the exit surface 16. The outer surface 28 is positioned around the exit surface 16. The exiting light from the exit surface 16 includes incident light from the bottom surface 24 and reflected light from the outer surface 28. The reflected light is the light that originates from the inner side surface 26 and is reflected.

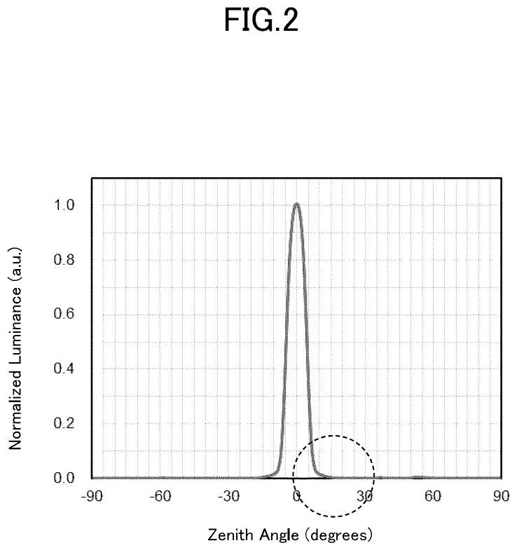

FIG. 2 is a luminance distribution diagram of the lighting device according to the embodiment. It can be seen that there is almost no light with a zenith angle exceeding ±20 degrees.

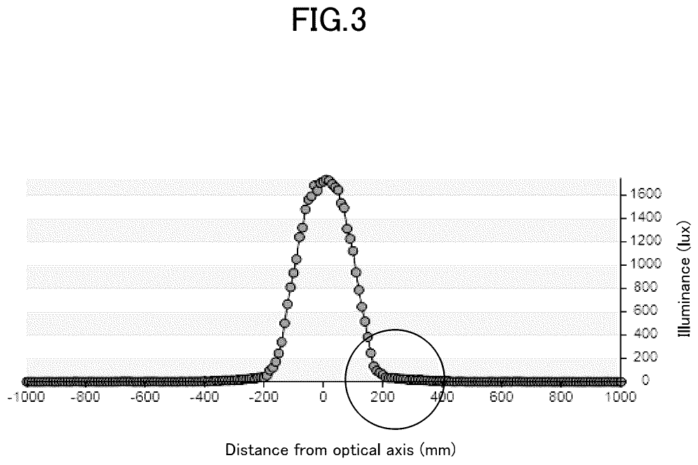

FIG. 3 is an illumination distribution diagram of the lighting device according to the embodiment. It can be seen that the spread of light is almost within ±200 mm.

In this embodiment, due to reduced light incidence on the bottom surface 24 of the recess 18, a higher level of light reflection from the outer surface 28 is possible, consequently achieving a narrow light distribution angle.

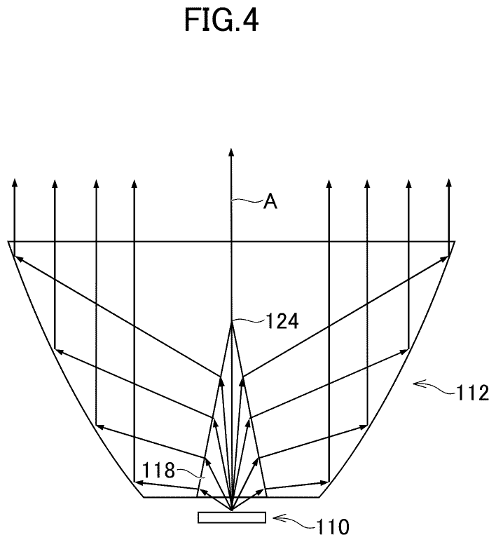

FIG. 4 is a schematic cross-sectional view of the lighting device according to a modification example of the embodiment. In this modification example, the bottom surface 124 of the recess 118 of the collimator lens 112 is substantially a point. Based on this, only light almost parallel to the optical axis A of the light source 110 enters the bottom surface 124.

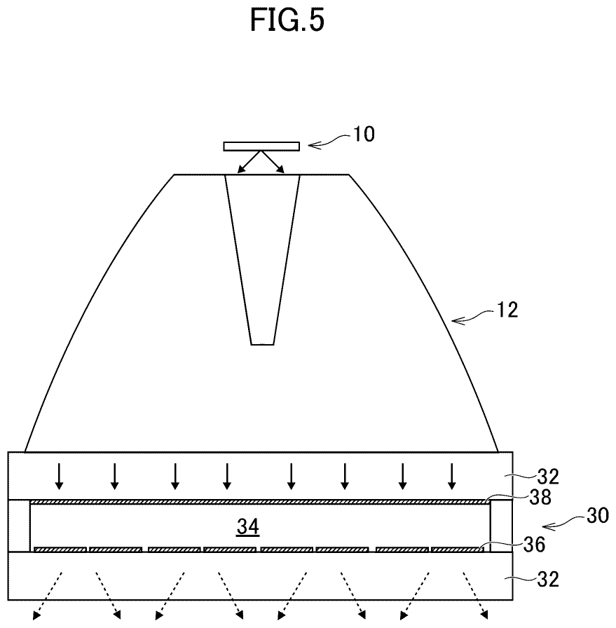

FIG. 5 is a schematic cross-sectional view of the lighting device according to an application example of the embodiment. The lighting device has a lens panel 30 in addition to the light source 10 and the collimator lens 12. The lens panel 30 has a pair of transparent substrates 32. A liquid crystal layer 34 of polymer-dispersed type is interposed between the pair of transparent substrates 32. The liquid crystal layer 34 is positioned between the first electrode 36 and the second electrode 38. The first electrode 36 and the second electrode 38 are transparent. With no voltage applied between the first electrode 36 and the second electrode 38, light travels directly through the liquid crystal layer 34, maintaining its original direction of propagation. In contrast, with a voltage applied between the first electrode 36 and the second electrode 38, the light scatters within the liquid crystal layer 34. This allows the light distribution angle to be adjusted.

The embodiments described above are not limited and different variations are possible. The structures explained in the embodiments may be replaced with substantially the same structures and other structures that can achieve the same effect or the same objective.

What is claimed is:

1. A lighting device comprising:
a light source capable of emitting light; and
a collimator lens including an incident surface of the light, an exit surface of the light, an outer surface around the incident surface and the exit surface,
wherein
the outer surface is capable of internally reflecting part of the light,
the collimator lens has a recess facing the light source,
the recess includes an interior surface, the interior surface includes a bottom surface smaller than an opening, the interior surface includes an inner side surface tapering toward the bottom surface, the inner side surface is shaped as rotating a straight line inclined at an angle of at least 10 degrees and at most 20 degrees with respect to an optical axis of the light, around the optical axis,
the light enters the bottom surface at a light distribution angle of only three degrees or less with respect to the optical axis, and enters the inner side surface at a light distribution angle of more than three degrees with respect to the optical axis,
exiting light from the exit surface includes incident light from the bottom surface and reflected light from the outer surface, and
the reflected light is light from the inner side surface.

2. The lighting device according to claim 1, wherein the bottom surface is a flat surface perpendicular to the optical axis.

3. The lighting device according to claim 1, wherein the exit surface is a flat surface perpendicular to the optical axis.

4. The lighting device according to claim 1, wherein the light from the light source is entirely incident on the interior surface of the recess.

5. The lighting device according to claim 1, wherein
the light source is positioned outside the recess, and
the light has a light distribution angle of less than 180 degrees.

6. The lighting device according to claim 1, wherein the outer surface is a curved surface that protrudes in a direction opposite to the optical axis, and
the curved surface is generated by rotating a curve around the optical axis.

7. The lighting device according to claim 1, wherein the collimator lens has, around the recess, a rear surface that is flat and extends in a direction perpendicular to the optical axis.

8. The lighting device according to claim 1, wherein the exit surface and the opening are circular, and
the opening is one fifth or less of the exit surface in diameter.

9. The lighting device according to claim 1, wherein the collimator lens is made of transparent resin or optical glass.

10. The lighting device according to claim 1, wherein the light source is a light-emitting diode or a filament.
